(19) United States
(12) Patent Application Publication
(10) Pub. No.: US 2019/0105760 A1
(43) Pub. Date: Apr. 11, 2019

(54) HIGH TORQUE RATCHET WRENCH

(71) Applicant: Chao-Chih Liu, Taichung City (TW)

(72) Inventor: Chao-Chih Liu, Taichung City (TW)

(21) Appl. No.: 15/725,282

(22) Filed: Oct. 5, 2017

(51) Int. Cl. B25B 13/46

(52) U.S. Cl. CPC B25B 13/463

(57) ABSTRACT

A ratchet wrench includes a handle and a head. A rotary member is rotatably received in the through hole of the head, and a switch unit is pivotably located in the reception recess communicating with the through hole. The rotary member includes a ratchet portion and an engaging member which has multiple first notches. The engaging member protrudes beyond the through hole. The switch unit includes a switch member and a fixing member respectively connected to the top and the bottom of the head. A pawl is controlled by the switch member and engaged with the ratchet portion. A latch is slidably connected to the switch member so as to be engaged with one of the first notches to allow the ratchet wrench to output high torque.

### BACKGROUND OF THE INVENTION

### 1. Fields of the Invention

The present invention relates to ratchet wrench, and more particularly, to a ratchet wrench that is able to output high torque.

### 2. Descriptions of Related Art

The conventional ratchet wrench known to applicant is disclosed in U.S. Pat. No. 8,596,169B2, and comprises a handle and a head member. The wrench head includes a receiving portion formed in the front end thereof to receive a rotating member and a hole formed therein. The hole includes a plurality of teeth arranged around the inner peripheral side thereof. The receiving portion includes a groove disposed on the rear end thereof to communicate with the receiving portion. The groove includes a through orifice fixed on the bottom end thereof, and the through orifice includes a wider recess formed on the bottom end thereof. A limiting device is secured in the through orifice of the head member and includes a retaining block to be fixed in the groove. The retaining block includes a post extending downward from the bottom end thereof. The post includes a notch disposed on the middle section thereof to receive a spring. The spring includes a sleeve fitted thereon. The post includes an annular slot formed adjacent to the bottom end thereof to retain with a C-shaped retainer.

However, once the retaining block is not located corresponding one of the outcuts, the retaining block cannot be engaged with the outcut, and the user has to re-adjust the position of the retaining block to be engaged with the outcut. This is not convenient to the users.

There are a post, a notch, a spring, a sleeve, a ball, an annular slot and a C-shaped retainer needed to be installed in the head member, the assembling time is long and the quality is not easily controlled.

The present invention intends to provide a ratchet wrench which eliminates the shortcomings of the conventional ratchet wrench.

### SUMMARY OF THE INVENTION

The present invention relates to a ratchet wrench and comprises a handle and a head connected to one end of the handle. The head has a through hole defined through the top and the bottom thereof, and a reception recess is defined in the inner periphery of the through hole.

A rotary member is rotatably received in the through hole and includes a ratchet portion and an engaging member, wherein the ratchet portion is defined in the outside of the rotary member and located in the through hole. The engaging member is formed on one end of the rotary member and protrudes beyond the through hole. The engaging member has multiple first notches defined in the outer periphery thereof.

A switch unit is pivotably located in the reception recess and has a switch member and a fixing member respectively connected to the top and the bottom of the head. A pawl, an activation member and a spring are located between the switch member and the fixing member. The spring is biased between the pawl and the activation member, and the pawl is engaged with the ratchet portion. The switch member and the fixing member are respectively mounted to the rotary member so that the ratchet portion is located between the switch member and the fixing member. The switch member is located between the engaging member and the ratchet portion. The switch member has a rod extending therefrom which is inserted into the reception recess so as to drive the pawl and the activation member to change driving direction of the ratchet portion.

A latch is connected to the top of the head and slidably connected with the switch member. The latch is slid toward the engaging member and engaged with one of the first notches so that the ratchet wrench is able to output a higher torque.

Preferably, each of the first notches includes a bridge face and two inclined faces which respectively extend from two ends of the bridge face so as to form a divergent opening of each first notch. A curved corner is connected between each of the two connection areas between the respective inclined faces and the bridge face to reduce stress concentration. The latch is a rectangular member including six sides, and two rounded corners are formed on two corners of the latch so as to be in contact with the curved corners when the latch is engaged with one of the first notches.

Preferably, the activation member has a path which faces the switch member. The rod is inserted in the path and pivots the activation member. The spring pushes the pawl along with pivotal movement of the activation member to be engaged with the ratchet portion.

Alternatively, the present invention provides another ratchet wrench which comprises a handle and a head connected to one end of the handle. The head includes a through hole defined through the top and the bottom thereof, and a reception recess is defined in the inner periphery of the through hole. A rotary member is rotatably received in the through hole and has a ratchet portion and a flange. The ratchet portion is defined in the outside of the rotary member and located in the through hole. The flange is formed beside the ratchet portion of the rotary member and protrudes beyond the through hole. The flange has multiple second notches defined in the outer periphery thereof.

A switch unit is pivotably located in the reception recess and has a switch member and a fixing member respectively connected to the top and the bottom of the head. A pawl, an activation member and a spring are located between the switch member and the fixing member. The spring is biased between the pawl and the activation member. The pawl is engaged with the ratchet portion. The switch member and the fixing member are respectively mounted to the rotary member so that the ratchet portion is located between the switch member and the fixing member. The fixing member is located between the flange and the ratchet portion. The switch member has a rod extending therefrom which is inserted into the reception recess so as to drive the pawl and the activation member to change driving direction of the ratchet portion.

A latch is connected to the bottom of the head and slidably connected with the fixing member. The latch is slid toward the flange, and engaged with one of the second notches.

Preferably, each of the second notches includes a bridge face and two inclined faces which respectively extend from two ends of the bridge face so as to form a divergent opening of each second notch. A curved corner is connected between each of the two connection areas between the respective inclined faces and the bridge face to reduce stress concentration. The latch is a rectangular member including six sides, and two rounded corners are formed on two corners of the latch so as to be in contact with the curved corners when the latch is engaged with one of the second notches.

Preferably, the activation member has a path which faces the switch member. The rod is inserted in the path and pivots the activation member. The spring pushes the pawl along with pivotal movement of the activation member to be engaged with the ratchet portion.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet wrench of the present invention;

FIG. 2 is an exploded view of the ratchet wrench of the present invention;

FIG. 3 is an exploded view of the switch member and the latch of the ratchet wrench of the present invention;

FIG. 4 is a top view of the ratchet wrench of the present invention;

FIG. 5 is a cross sectional view, taken along line V-V in FIG. 4;

FIG. 6 shows that the latch is engaged with one of the first notches of the engaging member of the ratchet wrench of the present invention;

FIG. 7 is a perspective view to show the second embodiment of the ratchet wrench of the present invention;

FIG. 8 is an exploded view of the second embodiment of the ratchet wrench of the present invention;

FIG. 9 is a cross sectional view, taken along line IX-IX in FIG. 7;

FIG. 10 is a cross sectional view, taken along line X-X in FIG. 9, and

FIG. 11 shows that the latch is engaged with one of the second notches of the flange of the ratchet wrench of the present invention.

### DETAILED DESCRIPTION OF THE PREFERRED EMBODIMENT

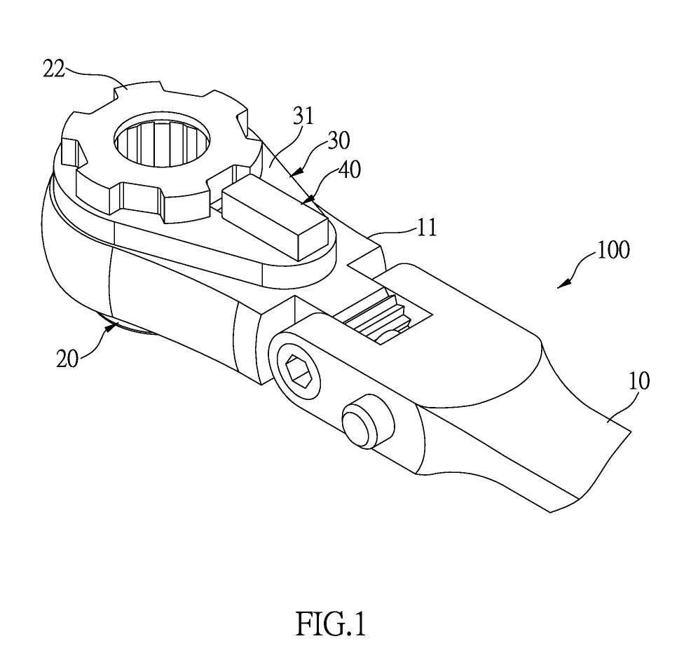

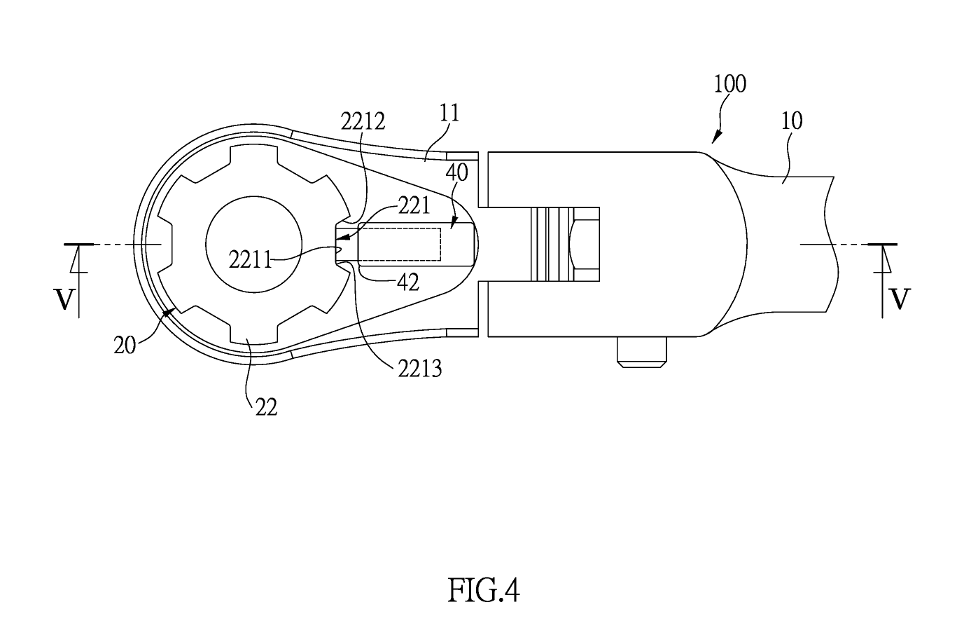

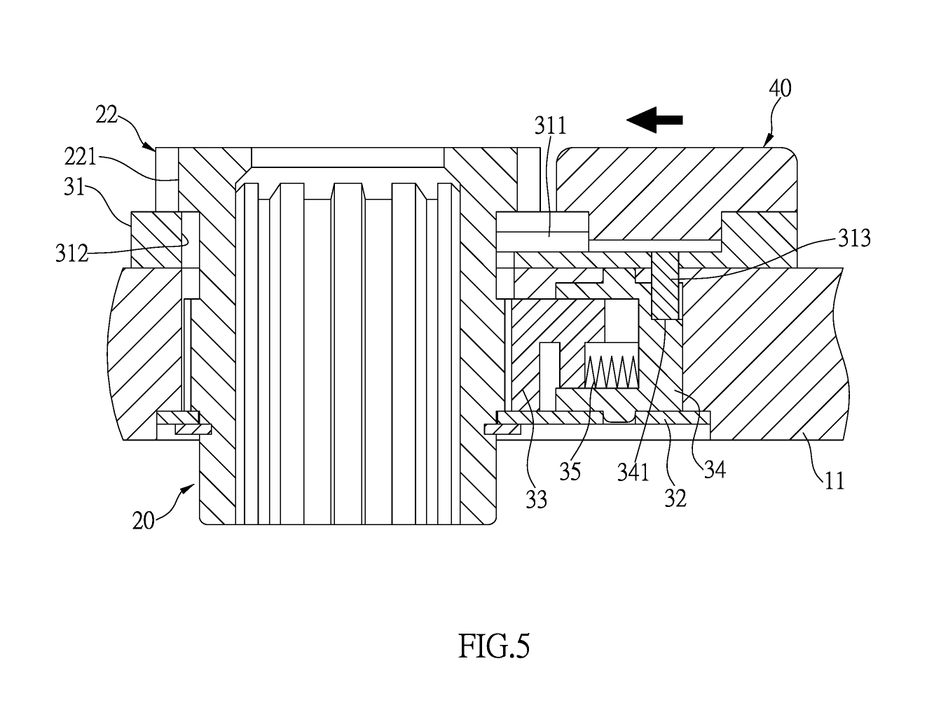

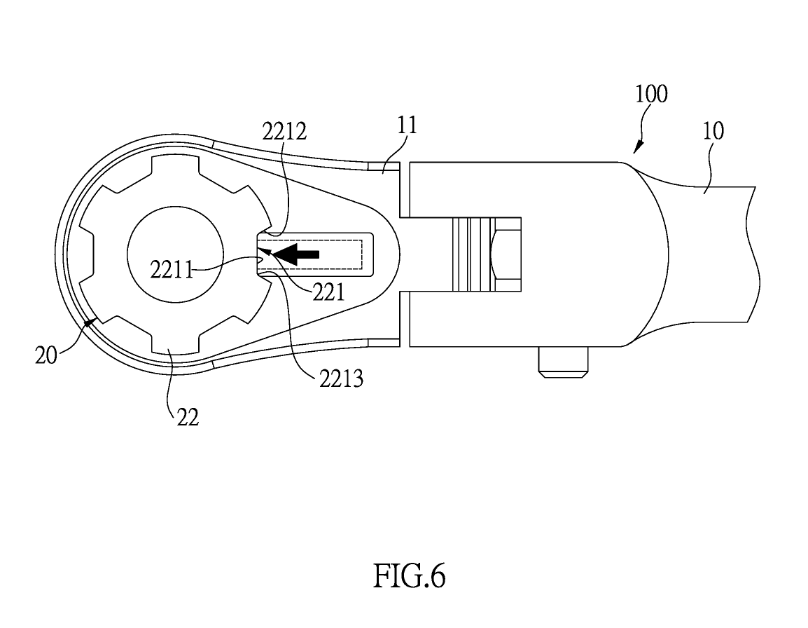

Referring to FIGS. 1 to 6, the ratchet wrench 100 of the present invention comprises a handle 10 and a head 11 connected to one end of the handle 10. The head 11 has a through hole 12 defined through the top and the bottom thereof, and a reception recess 13 is defined in the inner periphery of the through hole 12.

A rotary member 20 is rotatably received in the through hole 12 and includes a ratchet portion 21 and an engaging member 22, wherein the ratchet portion 21 is defined in the outside of the rotary member 20 and located in the through hole 12. The engaging member 22 is formed on one end of the rotary member 20 and protrudes beyond the through hole 12. The engaging member 22 has multiple first notches 221 defined in the outer periphery thereof.

A switch unit 30 is pivotably located in the reception recess 13 and has a switch member 31 and a fixing member 32 respectively connected to the top and the bottom of the head 11. A pawl 33, an activation member 34 and a spring 35 are located between the switch member 31 and the fixing member 32. The spring 35 is biased between the pawl 33 and the activation member 34, and the pawl 33 is engaged with the ratchet portion 21. The switch member 31 and the fixing member 32 are respectively mounted to the rotary member 20 so that the ratchet portion 21 is located between the switch member 31 and the fixing member 32. The switch member 31 is located between the engaging member 22 and the ratchet portion 21. The switch member 31 has a rod 313 extending therefrom which is inserted into the reception recess 13 so as to drive the pawl 33 and the activation member 34 to change driving direction of the ratchet portion 21.

A latch 40 is connected to the top of the head 11 and slidably connected with the switch member 31. The latch 40 is slid toward the engaging member 22 and engaged with one of the first notches 221 so that the ratchet wrench 100 is able to output a higher torque.

Each of the first notches 221 includes a bridge face 2211 and two inclined faces 2212 which respectively extend from two ends of the bridge face 2211 so as to form a divergent opening of each first notch 221. A curved corner 2213 is connected between each of the two connection areas between the respective inclined faces 2212 and the bridge face 2211 to reduce stress concentration. The latch 40 is a rectangular member including six sides, and two rounded corners 42 are formed on two corners of the latch 40 so that when the two rounded corners 42 are moved along the two inclined faces 2212 and enter into one of the first notches 221, the two rounded corners 42 are in contact with the curved corners 2213.

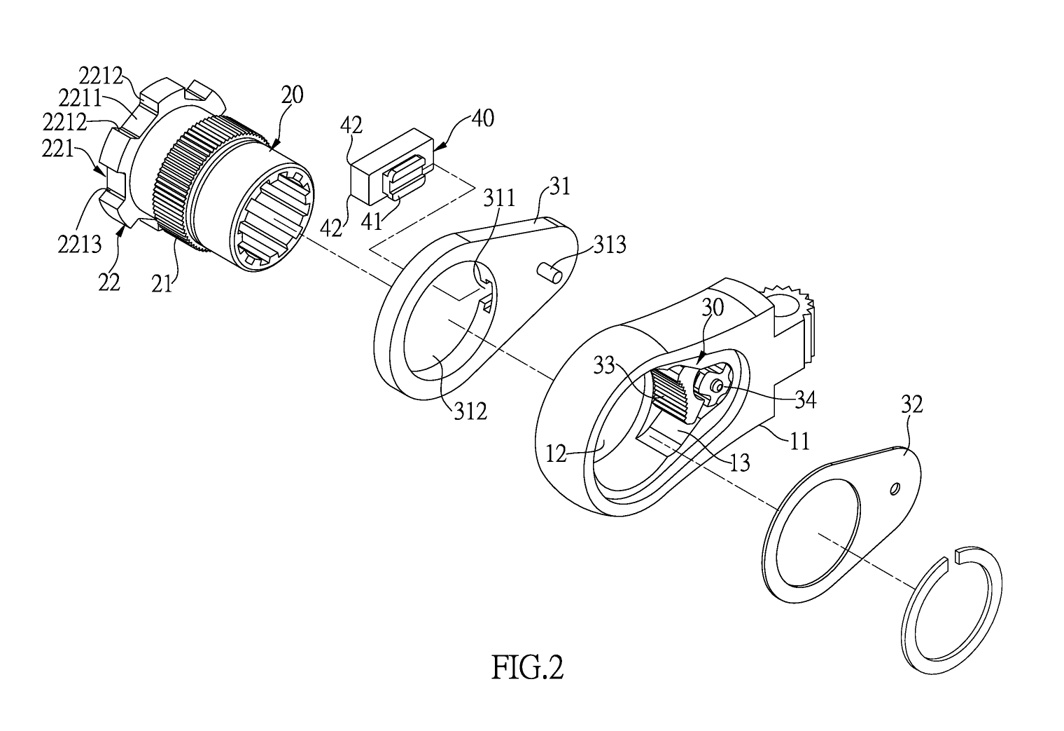

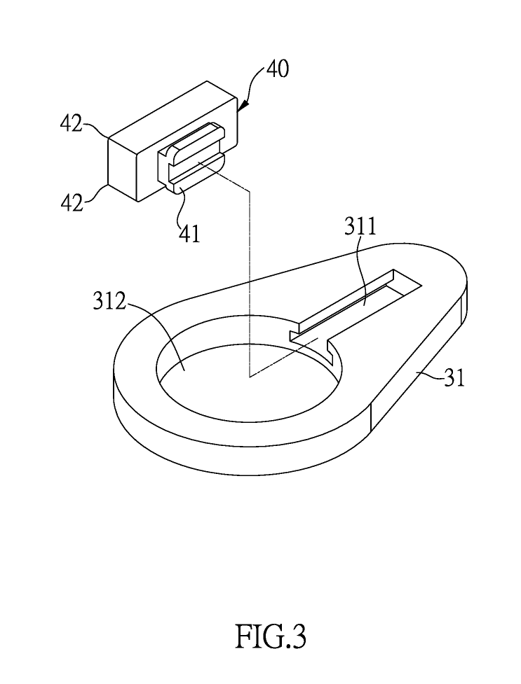

As shown in FIGS. 1 to 5, the activation member 34 has a path 341 which faces the switch member 31. The rod 313 is inserted in the path 341 and pivots the activation member 34. The spring 35 pushes the pawl 33 along with pivotal movement of the activation member 34 to be engaged with the ratchet portion 21. As shown in FIGS. 2 and 3, the switch member 31 includes a first groove 311, and the latch 40 has a slide 41 fixed to the underside thereof. The slide 41 is slidably engaged with the first groove 311. The switch member 31 further includes a first through hole 312 through which the rotary member 20 extends. The first through hole 312 communicates with one end of the first groove 311, such that the latch 40 is able to be engaged with one of the first notches 221. The engagement between the latch 40 and one of the first notches 221 provides a support so that the ratchet wrench 100 can output a high torque.

The structure of the ratchet wrench 100 is simple and the assembly processes are easily completed. The latch 40 can be conveniently pushed to be engaged with one of the first notches 2211 to allow the ratchet wrench 100 to output a high torque.

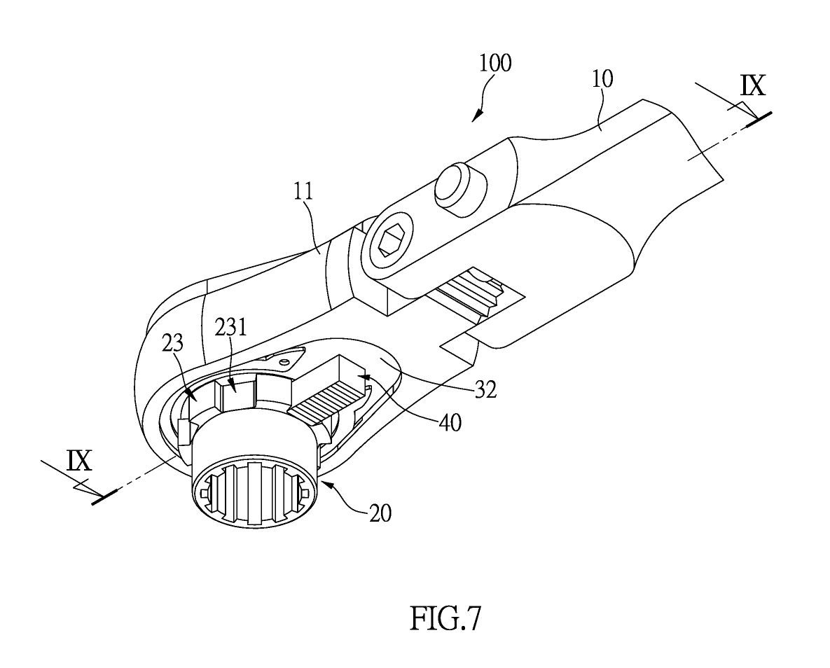

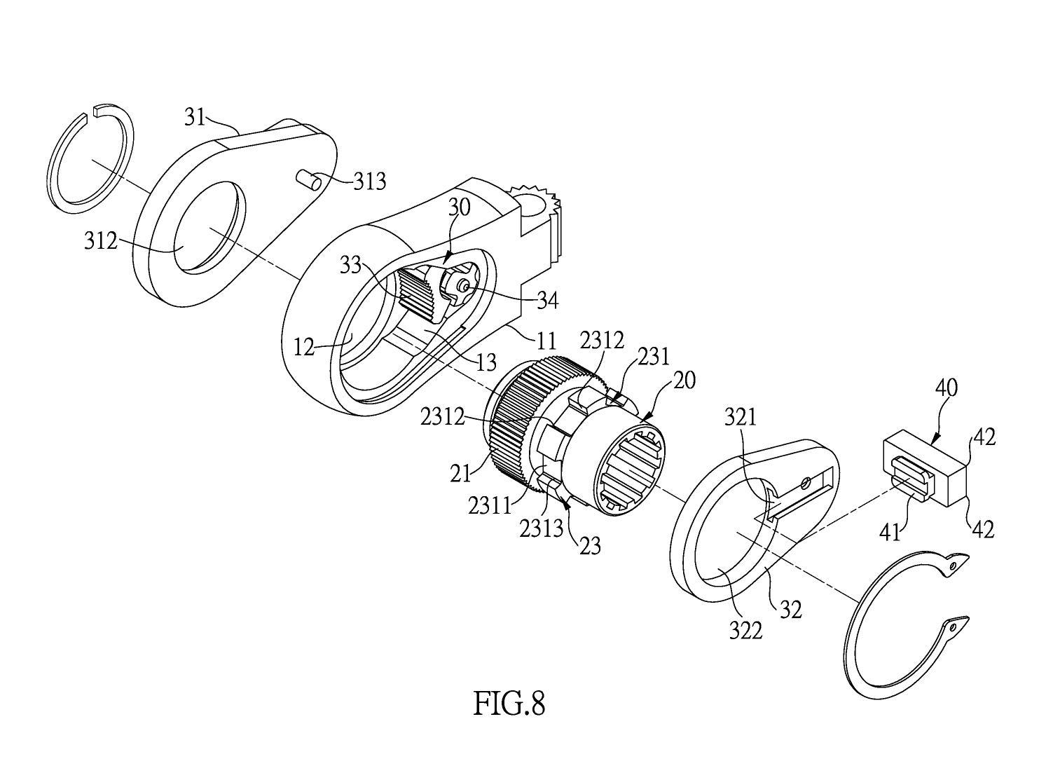

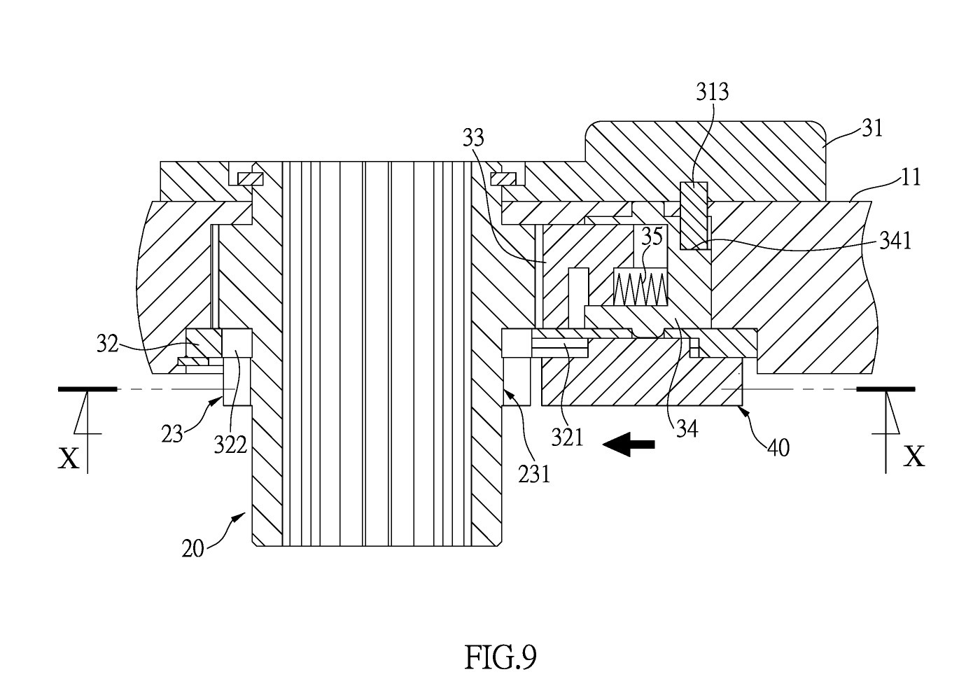

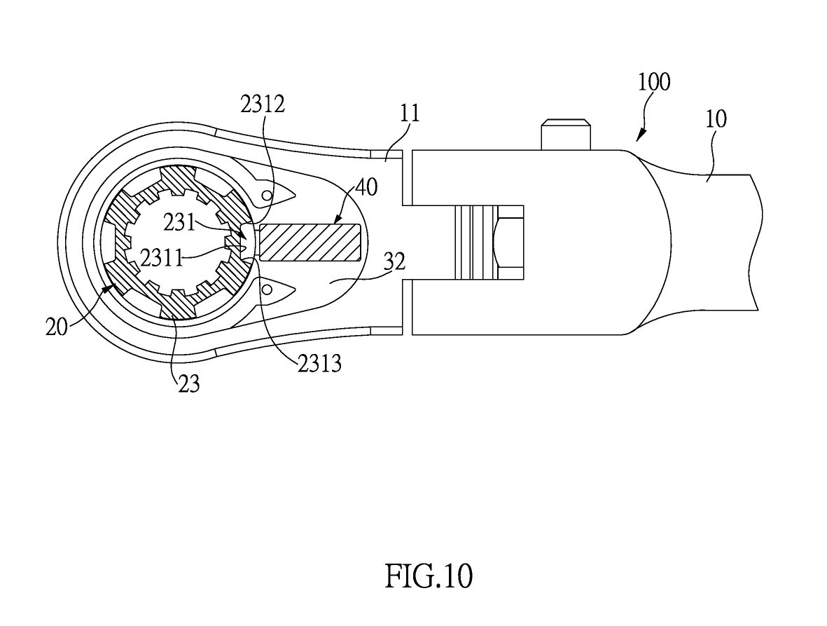

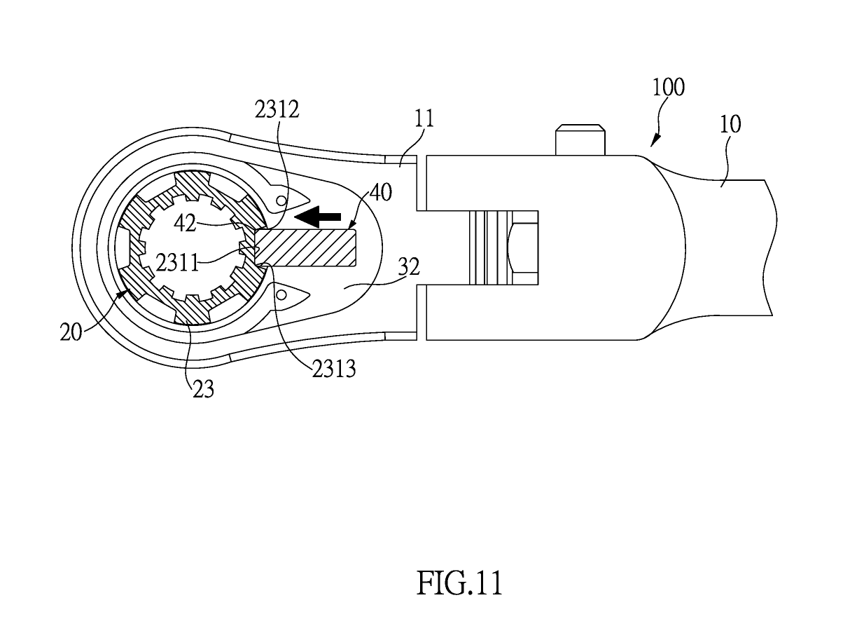

As shown in FIGS. 7 to 11, the present invention provides a second embodiment of the ratchet wrench 100 which comprises a handle 10 and a head 11 connected to one end of the handle 10. The head 11 includes a through hole 12 defined through the top and the bottom thereof, and a reception recess 13 is defined in the inner periphery of the through hole 12. A rotary member 20 is rotatably received in the through hole 12 and has a ratchet portion 21 and a flange 23. The ratchet portion 21 is defined in the outside of the rotary member 20 and located in the through hole 12. The flange 23 is formed beside the ratchet portion of the rotary member 20 and protrudes beyond the through hole 12. The flange 23 has multiple second notches 231 defined in the outer periphery thereof.

A switch unit 30 is pivotably located in the reception recess 13 and has a switch member 31 and a fixing member 32 respectively connected to the top and the bottom of the head 11. A pawl 33, an activation member 34 and a spring 35 are located between the switch member 31 and the fixing member 32. The spring 35 is biased between the pawl 33 and the activation member 34. The pawl 33 is engaged with the ratchet portion 21. The switch member 31 and the fixing member 32 are respectively mounted to the rotary member 20 so that the ratchet portion 21 is located between the switch member 31 and the fixing member 32. The fixing member 32 is located between the flange 23 and the ratchet portion 21. The switch member 31 has a rod 313 extending therefrom which is inserted into the reception recess 13 so as to drive the pawl 33 and the activation member 34 to change driving direction of the ratchet portion 21.

A latch 40 is connected to the bottom of the head 11 and slidably connected with the fixing member 32. The latch 40 is slid toward the flange 23, and engaged with one of the second notches 231.

The activation member 34 has a path 341 which faces the switch member 31. The rod 313 is inserted in the path 341 and pivots the activation member 34. The spring 35 pushes the pawl 33 along with pivotal movement of the activation member 34 to be engaged with the ratchet portion 21.

The fixing member 32 includes a second groove 321, and the latch 40 has a slide 41 fixed to the underside thereof. The slide 41 is slidably engaged with the second groove 321. The fixing member 32 further includes a second through hole 322 through which the rotary member 20 extends. The second through hole 322 communicates with one end of the second groove 321, such that the latch 40 is able to be engaged with one of the second notches 231. The engagement between the latch 40 and one of the second notches 231 provides a support so that the ratchet wrench 100 can output a high torque.

Each of the second notches 231 includes a bridge face 2311 and two inclined faces 2312 which respectively extend from two ends of the bridge face 2311 so as to form a divergent opening of each second notch 231. A curved corner 2313 is connected between each of the two connection areas between the respective inclined faces 2312 and the bridge face 2311 to reduce stress concentration. The latch 40 is a rectangular member including six sides, and two rounded corners 42 are formed on two corners of the latch 40 so as to be in contact with the curved corners 2313 when the latch 40 is engaged with one of the second notches 231.

While we have shown and described the embodiment in accordance with the present invention, it should be clear to those skilled in the art that further embodiments may be made without departing from the scope of the present invention.

What is claimed is:

1. A ratchet wrench (100) comprising:
a handle (10) and a head (11) connected to one end of the handle (10), the head (11) having a through hole (12) defined through a top and a bottom thereof, and a reception recess (13) defined in an inner periphery of the through hole (12), a rotary member (20) rotatably received in the through hole (12) and a switch unit (30) pivotably located in the reception recess (13);
the rotary member (20) having a ratchet portion (21) and an engaging member (22), the ratchet portion (21) defined in an outside of the rotary member (20) and located in the through hole (12), the engaging member (22) formed on one end of the rotary member (20) and protruding beyond the through hole (12), the engaging member (22) having multiple first notches (221) defined in an outer periphery thereof;
the switch unit (30) having a switch member (31) and a fixing member (32) respectively connected to the top and the bottom of the head (11), a pawl (33), an activation member (34) and a spring (35) located between the switch member (31) and the fixing member (32), the spring (35) biased between the pawl (33) and the activation member (34), the pawl (33) engaged with the ratchet portion (21), the switch member (31) and the fixing member (32) respectively mounted to the rotary member (20) so that the ratchet portion (21) is located between the switch member (31) and the fixing member (32), the switch member (31) located between the engaging member (22) and the ratchet portion (21), the switch member (31) having a rod (313) extending therefrom which is inserted into the reception recess (13) so as to drive the pawl (33) and the activation member (34) to change driving direction of the ratchet portion (21), and
a latch (40) connected to the top of the head (11) and slidably connected with the switch member (31), the latch (40) being slid from the handle (10) toward the engaging member (22), and engaged with one of the first notches (221).

2. The ratchet wrench as claimed in claim 1, wherein each of the first notches (221) includes a bridge face (2211) and two inclined faces (2212) which respectively extend from two ends of the bridge face (2211) so as to form a divergent opening of each first notch (221), a curved corner (2213) is connected between each of two connection areas between the respective inclined faces (2212) and the bridge face (2211) to reduce stress concentration, the latch (40) is a rectangular member including six sides, two rounded corners (42) are formed on two corners of the latch (40) so as to be in contact with the curved corners (2213) when the latch (40) is engaged with one of the first notches (221).

3. The ratchet wrench as claimed in claim 1, wherein the activation member (34) has a path (341) which faces the switch member (31), the rod (313) is inserted in the path (341) and pivots the activation member (34), the spring (35) pushes the pawl (33) along with pivotal movement of the activation member (34) to be engaged with the ratchet portion (21).

4. A ratchet wrench (100) comprising:
a handle (10) and a head (11) connected to one end of the handle (10), the head (11) having a through hole (12) defined through a top and a bottom thereof, and a reception recess (13) defined in an inner periphery of the through hole (12), a rotary member (20) rotatably received in the through hole (12) and a switch unit (30) pivotably located in the reception recess (13);
the rotary member (20) having a ratchet portion (21) and a flange (23), the ratchet portion (21) defined in an outside of the rotary member (20) and located in the through hole (12), the flange (23) formed beside the ratchet portion (21) of the rotary member (20) and protruding beyond the through hole (12), the flange (23) having multiple second notches (231) defined in an outer periphery thereof;
the switch unit (30) having a switch member (31) and a fixing member (32) respectively connected to the top and the bottom of the head (11), a pawl (33), an activation member (34) and a spring (35) located between the switch member (31) and the fixing member (32), the spring (35) biased between the pawl (33) and the activation member (34), the pawl (33) engaged with the ratchet portion (21), the switch member (31) and the fixing member (32) respectively mounted to the rotary member (20) so that the ratchet portion (21) is located between the switch member (31) and the fixing member (32), the fixing member (32) located between the flange (23) and the ratchet portion (21), the switch member (31) having a rod (313) extending therefrom which is inserted into the reception recess (13) so as to drive the pawl (33) and the activation member (34) to change driving direction of the ratchet portion (21), and
a latch (40) connected to the bottom of the head (11) and slidably connected with the fixing member (32), the latch (40) being slid (10) toward the flange (23), and engaged with one of the second notches (231).

5. The ratchet wrench as claimed in claim 4, wherein each of the second notches (231) includes a bridge face (2311) and two inclined faces (2312) which respectively extend from two ends of the bridge face (2311) so as to form a divergent opening of each second notch (231), a curved corner (2313) is connected between each of two connection areas between the respective inclined faces (2312) and the bridge face (2311) to reduce stress concentration, the latch (40) is a rectangular member including six sides, two rounded corners (42) are formed on two corners of the latch (40) so as to be in contact with the curved corners (2313) when the latch (40) is engaged with one of the second notches (231).

6. The ratchet wrench as claimed in claim 4, wherein the activation member (34) has a path (341) which faces the switch member (31), the rod (313) is inserted in the path (341) and pivots the activation member (34), the spring (35) pushes the pawl (33) along with pivotal movement of the activation member (34) to be engaged with the ratchet portion (21).
